(19) United States
(12) Patent Application Publication
(10) Pub. No.: US 2026/0028796 A1
(43) Pub. Date: Jan. 29, 2026

(54) WORK MACHINE

(71) Applicant: KOMATSU LTD., Tokyo (JP)

(72) Inventors: Yuki SHIMANO, Tokyo (JP); Shoichiro ASAI, Tokyo (JP); Takahiro HIRAMA, Tokyo (JP); Naoki HIEDA, Tokyo (JP); Satoru SHINTANI, Tokyo (JP)

(21) Appl. No.: 18/998,974

(22) PCT Filed: Aug. 23, 2023
(86) PCT No.: PCT/JP2023/030375

§ 371 Date: Jan. 27, 2025

(30) Foreign Application Priority Data
Sep. 2, 2022 (JP) 2022-140224

(51) Int. Cl. E02F 9/08; E02F 9/26; H01Q 1/32

(52) U.S. Cl. CPC E02F 9/0858; E02F 9/26; H01Q 1/3275

(57) ABSTRACT

A work machine includes a vehicle body upper surface frame, a housing space, and a fixing part. The housing space is positioned below the vehicle body upper surface frame. The fixing part fixes an antenna to the vehicle body upper surface frame from inside the housing space so that at least a portion of the antenna is disposed above the vehicle body upper surface frame.

### CROSS-REFERENCE TO RELATED APPLICATIONS

This application is a U.S. National stage application of International Application No. PCT/JP2023/030375, filed on Aug. 23, 2023. This U.S. National stage application claims priority under 35 U.S.C. § 119(a) to Japanese Patent Application No. 2022-140224, filed in Japan on Sep. 2, 2022, the entire contents of which are hereby incorporated herein by reference.

### BACKGROUND

### Technical Field

The present disclosure relates to a work machine.

### Background Information

A work machine that comprises an antenna for a global navigation satellite system (GNSS) is known in the prior art.

For example, in the work machine described in Japanese Patent Laid-open No. 2015-21320, an antenna is disposed on the tip end part of a mast that is provided standing on the vehicle body upper surface.

### SUMMARY

However, when the antenna is disposed at the tip end part of the mast, the antenna can be easily removed from the outside and thus it is easy to steal the antenna. As a result, in order to prevent theft, there is a need to remove the antenna from the mast after work is completed but this is difficult. There is also a concern that the harness may become degraded while repeatedly attaching and detaching the harness to and from the antenna.

An object of the present disclosure is to provide a work machine in which the removal of the antenna from outside is prevented.

A work machine according to a first embodiment of the present disclosure comprises a vehicle body upper surface frame, a housing space, and a fixing part. The housing space is positioned below the vehicle body upper surface frame. The fixing part is configured to fix an antenna to the vehicle body upper surface frame from inside the housing space so that at least a portion of the antenna is disposed above the vehicle body upper surface frame.

According to the present disclosure, there can be provided a work machine in which the removal of the antenna from outside is prevented.

### BRIEF DESCRIPTION OF DRAWINGS

FIG. 1 is a rearward perspective view of a hydraulic excavator according to an embodiment.

FIG. 2 is a leftward perspective view of an exterior cover according to the embodiment.

FIG. 3 is a right front perspective view of the exterior cover according to the embodiment.

FIG. 4 is a rightward perspective view of the exterior cover according to the embodiment.

FIG. 5 is a left front perspective view of the exterior cover according to the embodiment.

FIG. 6 is a rearward perspective view of a first GNSS antenna according to the embodiment.

FIG. 7 is a cross-sectional view of a fixing structure of the first GNSS antenna according to the embodiment.

FIG. 8 is an exploded perspective view of the fixing structure of the first GNSS antenna according to the embodiment.

FIG. 9 is a downward perspective view of the fixing structure of the first GNSS antenna according to the embodiment.

FIG. 10 is a rearward perspective view of a second GNSS antenna according to the embodiment.

FIG. 11 is a cross-sectional view of a fixing structure of the second GNSS antenna according to the embodiment.

FIG. 12 is an exploded perspective view of the fixing structure of the second GNSS antenna according to the embodiment.

FIG. 13 is a downward perspective view of an insulation member according to the embodiment.

FIG. 14 is a downward perspective view when the attachment tool in FIG. 13 is removed.

FIG. 15 is a perspective view illustrating a lid according to a fourth modified example.

### DETAILED DESCRIPTION OF EMBODIMENT(S)

### Hydraulic Excavator 1

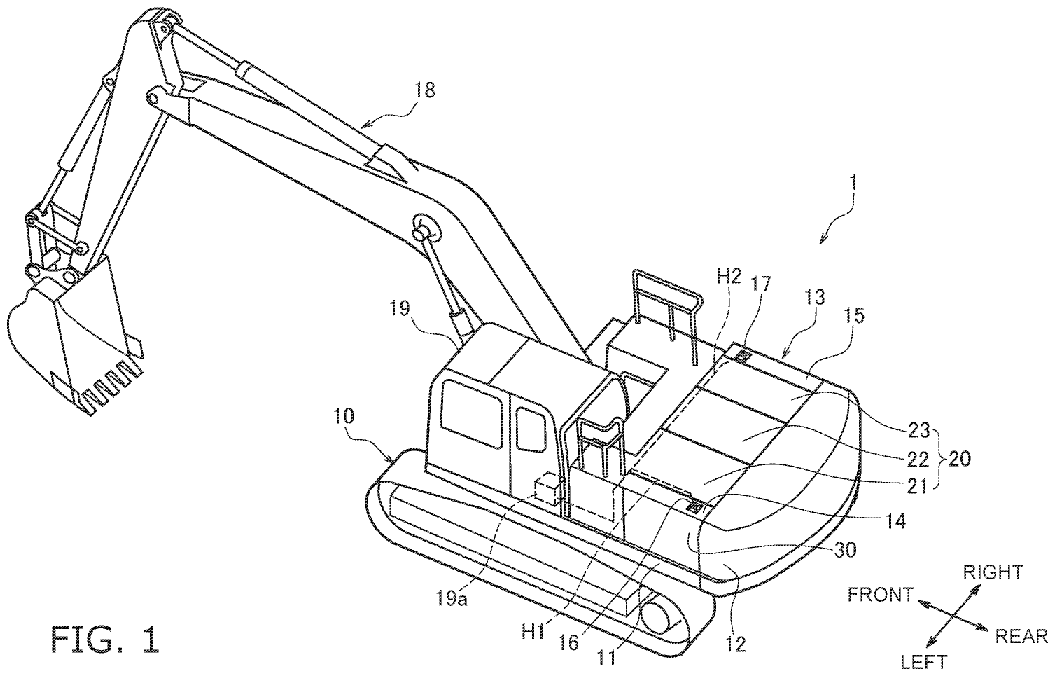

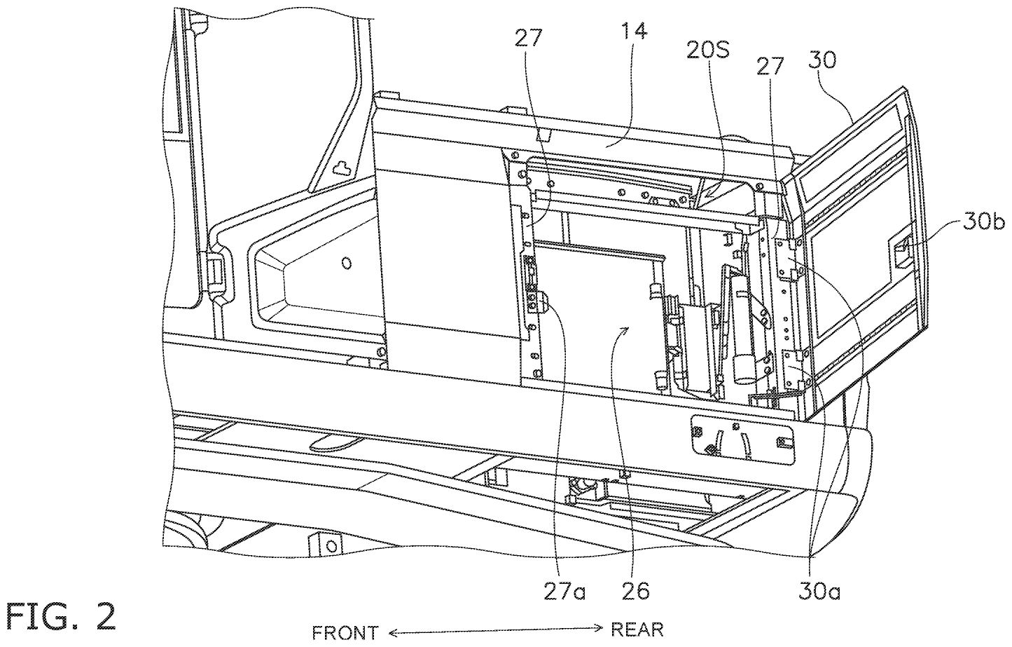

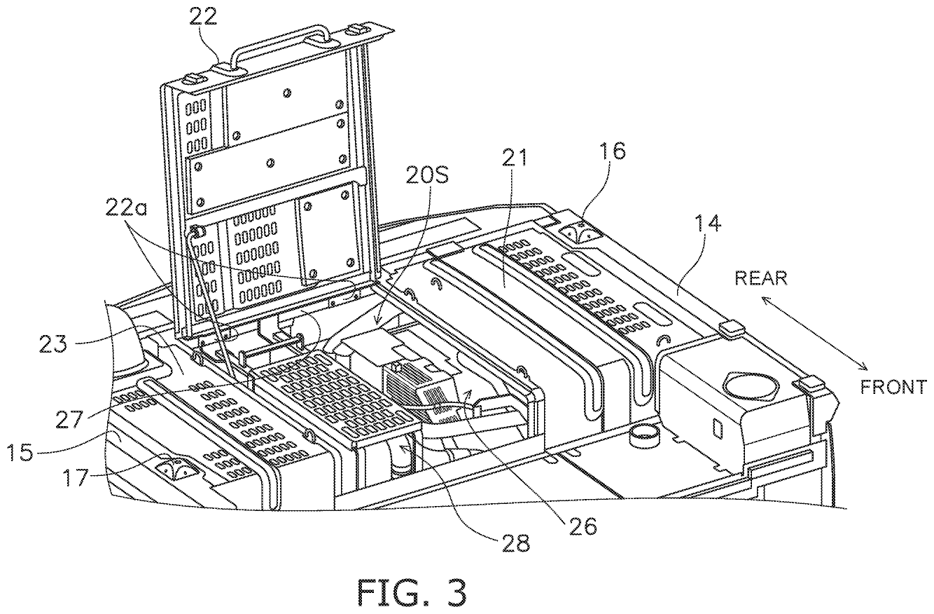

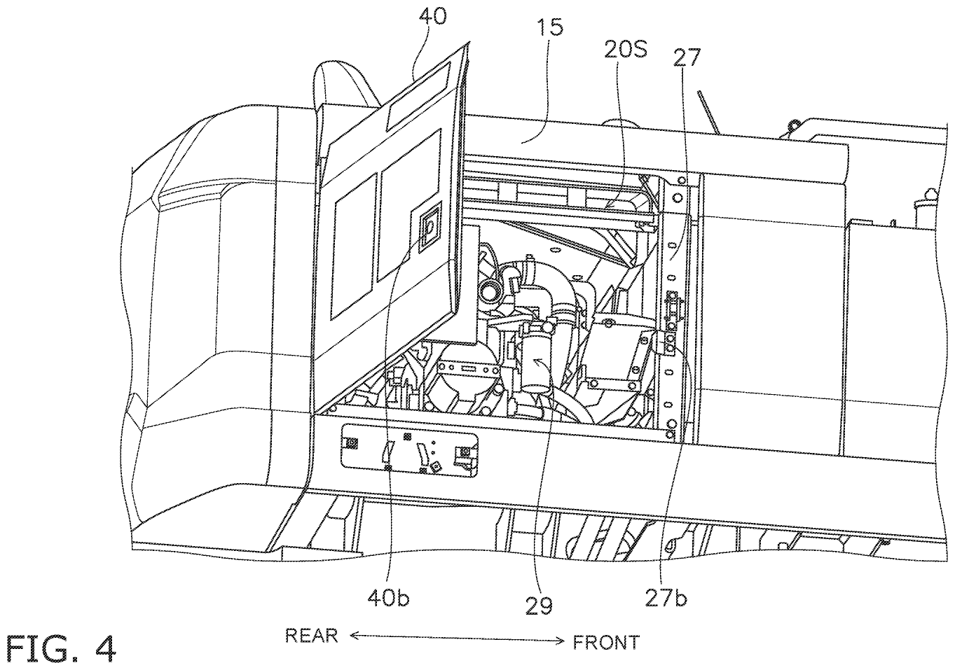

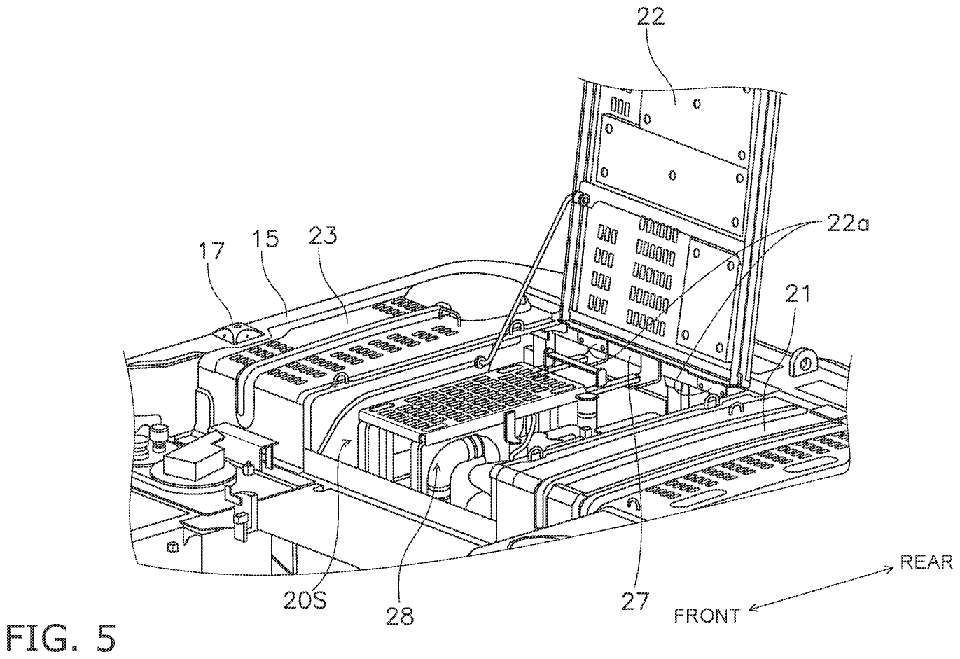

A configuration of a hydraulic excavator 1 according to an embodiment shall be explained in detail with reference to the drawings. FIG. 1 is a rearward perspective view of the hydraulic excavator 1. FIG. 2 is a leftward perspective view of an exterior cover 13. FIG. 3 is a right front perspective view of the exterior cover 13. FIG. 4 is a rightward perspective view of the exterior cover 13. FIG. 5 is a left front perspective view of the exterior cover 13.

The hydraulic excavator 1 is an example of a “work machine” according to the present disclosure The hydraulic excavator 1 comprises an undercarriage 10, a rotating super structure 11, a counterweight 12, the exterior cover 13, a left vehicle body upper surface frame 14, a right vehicle body upper surface frame 15, a first GNSS antenna 16, a second GNSS antenna 17, a work implement 18, and a cab 19. The rotating super structure 11, the counterweight 12, the exterior cover 13, the left vehicle body upper surface frame 14, the right vehicle body upper surface frame 15, and the cab 19 constitute the main vehicle body elements of the hydraulic excavator 1. The first GNSS antenna 16 and the second GNSS antenna 17 are both examples of an “antenna” according to the present disclosure.

The undercarriage 10 has a pair of crawler belts (only the left crawler belt is illustrated in FIG. 1) that are able to rotate independent of each other. The hydraulic excavator 1 moves forward and backward and left and right by rotating the pair of crawler belts.

The rotating super structure 11 is disposed on the undercarriage 100. The rotating super structure 11 is able to rotate. The rotating super structure 11 supports the counterweight 12, the exterior cover 13, the work implement 18, and the cab 19.

The counterweight 12 is disposed at the rear end part of the rotating super structure 11. The counterweight 12 is constituted, for example, by pouring concrete or the like into a box made of steel plates. The counterweight 12 is used to maintain the vehicle body balance while doing excavation work and the like.

The exterior cover 13 is disposed on the rotating super structure 11. The exterior cover 13 is disposed in front of the counterweight 12 and behind the cab 19. As illustrated in FIGS. 2 and 4, the exterior cover 13 is attached to a supporting frame 27. The supporting frame 27 is disposed on the rotating super structure 11. The supporting frame 27 is disposed along the outer edge of a belowmentioned equipment room 20S.

As illustrated in FIG. 1, the exterior cover 13 has a vehicle body upper surface cover 20, a left side surface cover 30, and a right side surface cover 40. In the present embodiment, the vehicle body upper surface cover 20 is divided into a left upper surface cover 21, an engine hood 22, and a right upper surface cover 23.

illustrated in FIGS. 2 and 4, the equipment room 20S is positioned below the vehicle body upper surface cover 20. A cooling device 26 (see FIG. 2) such as a radiator or a cooling fan, a heat source 28 (see FIG. 3) such as an engine or a waste gas treatment device, and an auxiliary machine 29 (see FIG. 4) such as a hydraulic fluid tank, a hydraulic fluid pump, or a fuel tank, are disposed in the equipment room 20S. The equipment room 20S is an example of a “housing space” according to the present disclosure. A state in which the left side surface cover 30 is open is illustrated in FIG. 2, a state in which the engine hood 22 is open is illustrated in FIG. 3, and a state in which the right side surface cover 40 is open is illustrated in FIG. 4.

In the present embodiment, the cooling device 26 is disposed straddling below the left upper surface cover 21 and the engine hood 22, the heat source 28 is disposed straddling below the engine hood 22 and the right upper surface cover 23, and the auxiliary machine 29 is disposed below the right upper surface cover 23.

As illustrated in FIG. 1, the left upper surface cover 2 is disposed on the left side of the engine hood 22. The left upper surface cover 2 is fixed to the supporting frame 27 by bolt fastening and cannot be opened or closed.

As illustrated in FIG. 1, the engine hood 22 is disposed between the left upper surface cover 21 and the right upper surface cover 23 in the vehicle width direction. As illustrated in FIG. 3, the rear end part of the engine hood 22 is supported by hinges 22a so as to allow opening and closing. The hinges 22a are coupled to the engine hood 22 and the supporting frame 27. The engine hood 22 can be opened and closed between a closed position (see FIG. 1) and an open position (see FIG. 3).

As illustrated in FIG. 1, the right upper surface cover 23 is disposed on the right side of the engine hood 22. The right upper surface cover 23 is fixed to the supporting frame 27 by bolt fastening and cannot be opened or closed.

As illustrated in FIG. 1, the left side surface cover 30 is disposed on the left and below the left upper surface cover 21. The left side surface cover 30 covers the (leftward) side of the equipment room 20S. As illustrated in FIG. 2, the rear end part of the left side surface cover 30 is supported by hinges 30a so as to allow opening and closing. The hinges 30a are coupled to the left side surface cover 30 and the supporting frame 27. The left side surface cover 30 can be opened and closed between a closed position (see FIG. 1) and an open position (see FIG. 2). The left side surface cover 30 has a locking mechanism 30b. The left side surface cover 30 can be locked in the closed position by engaging a latch of the locking mechanism 30b to a latch receiver 27a attached to the supporting frame 27.

The right side surface cover 40 is disposed on the right and below the right upper surface cover 23. The right side surface cover 40 covers the (rightward) side of the equipment room 20S. The rear end part of the right side surface cover 40 is supported with hinges (not illustrated) so as to allow opening and closing in the same way as the left side surface cover 30. The right side surface cover 40 can be opened and closed between a closed position and an open position (see FIG. 4). The right side surface cover 40 has a locking mechanism 40b. The locking mechanism 40b can be locked in the closed position by engaging a latch of the locking mechanism 40b to a latch receiver 27b attached to the supporting frame 27.

The left vehicle body upper surface frame 14 is disposed on the supporting frame 27. The left vehicle body upper surface frame 14 extends in the front-back direction. The left vehicle body upper surface frame 14 is disposed to the left of the vehicle body upper surface cover 20 (specifically, the left upper surface cover 21) and above the left side surface cover 30. The first GNSS antenna 16 is fixed to the left vehicle body upper surface frame 14. The left vehicle body upper surface frame 14 is an example of a “vehicle body upper surface frame” according to the present disclosure.

The right vehicle body upper surface frame 15 is disposed on the supporting frame 27. The right vehicle body upper surface frame 15 extends in the front-back direction. The right vehicle body upper surface frame 15 is disposed to the right of the vehicle body upper surface cover 20 (specifically, the right upper surface cover 23) and above the right side surface cover 40. The second GNSS antenna 17 is fixed to the right vehicle body upper surface frame 15. The right vehicle body upper surface frame 15 is an example of a “vehicle body upper surface frame” according to the present disclosure.

The first GNSS antenna 16 is an antenna used in a global navigation satellite system (GNSS). As illustrated in FIG. 1, the first GNSS antenna 16 is fixed to the left vehicle body upper surface frame 14. At least a portion of the first GNSS antenna 16 is disposed above the left vehicle body upper surface frame 14. The first GNSS antenna 16 is disposed to the rear of the cab 19. The first GNSS antenna 16 is connected to a controller 19a inside the cab 19 by means of a first harness H1. The first harness H1 extends from the first GNSS antenna 16 toward the right and front. A fixing structure of the first GNSS antenna 16 is explained below.

The second GNSS antenna 17 is an antenna used in GNSS. As illustrated in FIG. 1, the second GNSS antenna 17 is fixed to the right vehicle body upper surface frame 15. At least a portion of the second GNSS antenna 17 is disposed above the right vehicle body upper surface frame 15. The second GNSS antenna 17 is disposed on the opposite side to the first GNSS antenna 16 relative to the center in the vehicle width direction of the hydraulic excavator 1. The second GNSS antenna 17 is connected to the controller 19a inside the cab 19 by means of a second harness H2. The second harness H2 extends from the second GNSS antenna 17 toward the left and front. A fixing structure of the second GNSS antenna 17 is explained below.

As illustrated in FIG. 1, the first GNSS antenna 16 is disposed to the left of the vehicle body upper surface cover 20 and the second GNSS antenna 17 is disposed to the right of the vehicle body upper surface cover 20. Consequently, a distance between the first GNSS antenna 16 and the second GNSS antenna 17 in the vehicle width direction can be assured whereby the accuracy of bearing calculation results of the vehicle body using the positioning results of the antennas can be improved.

Also as illustrated in FIG. 1, the first GNSS antenna 16 is disposed at the rear end part of the left vehicle body upper surface frame 14 and the second GNSS antenna 17 is disposed at the front end part of the right vehicle body upper surface frame 15. Consequently, the distance between the first GNSS antenna 16 and the second GNSS antenna 17 in the vehicle width direction as well as the front-back direction can be further assured whereby the accuracy of bearing calculation results of the vehicle body using the positioning results of the antennas can be improved.

Moreover, as illustrated in FIG. 1, the first GNSS antenna 16 disposed to the rear of the cab 19 is disposed at the end rear part of the left vehicle body upper surface frame 14. Consequently, the first GNSS antenna 16 can be spaced away from the cab 19 whereby the sky factor of the first GNSS antenna 16 can be increased. As a result, the positioning accuracy of the first GNSS antenna 16 can be improved.

The work implement 18 is mounted in a swingable manner at the front end part of the rotating super structure 11. The work implement 18 is disposed beside the cab 19.

The cab 19 is disposed on the rotating super structure 11. The cab 19 is disposed in front of the exterior cover 13. The cab 19 is disposed beside the work implement 18. An operator's seat and operating units may be disposed inside the cab 19.

### First GNSS Antenna 16

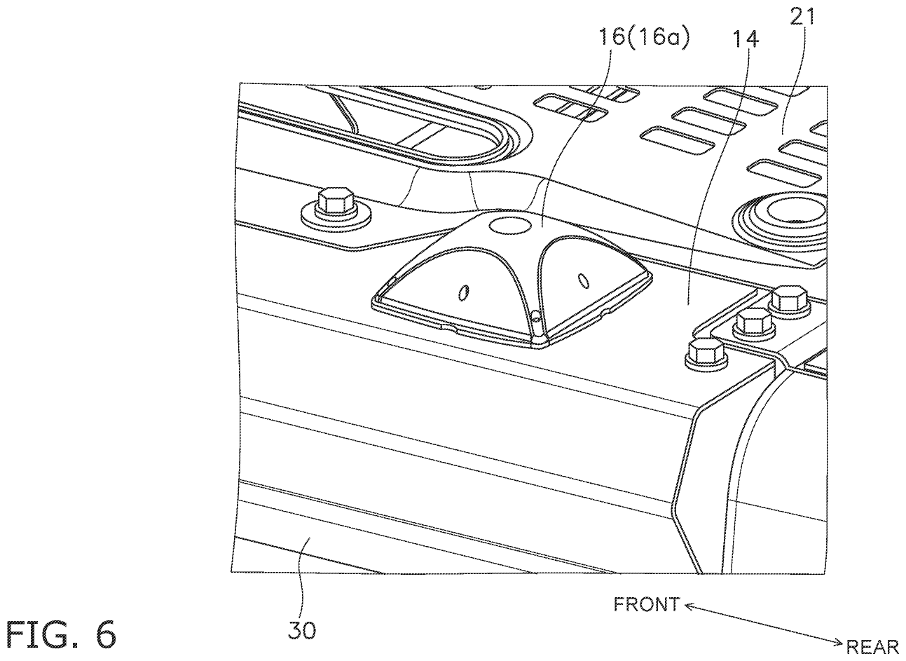

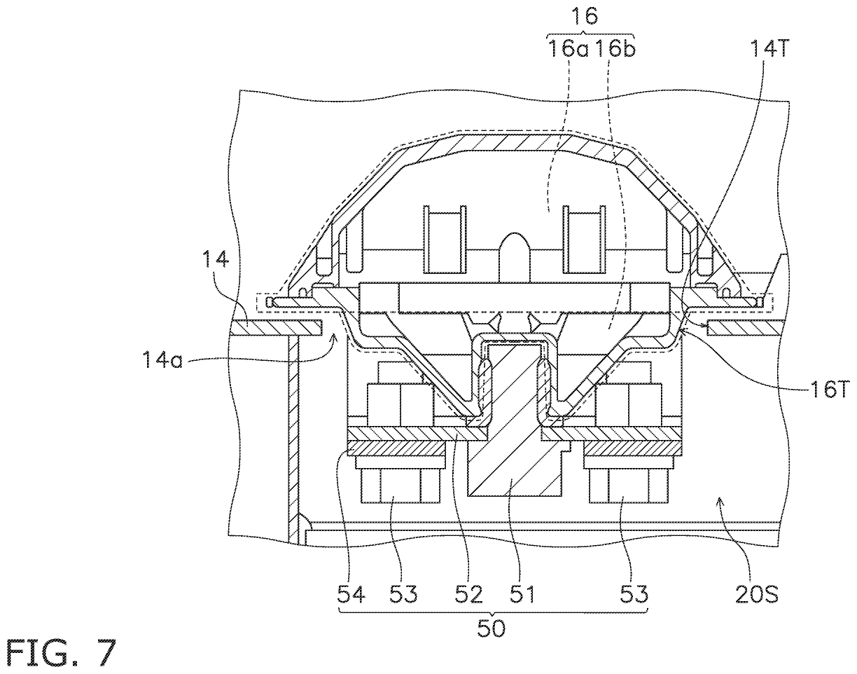

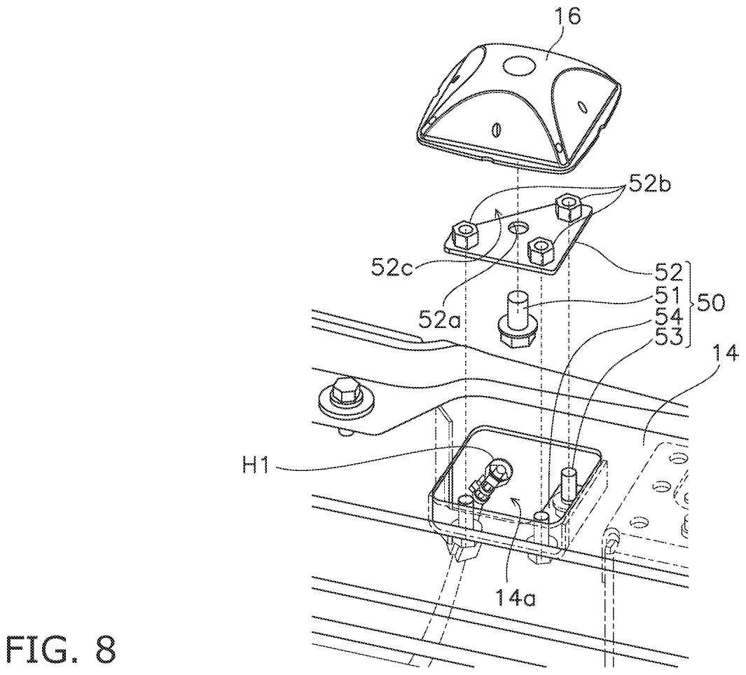

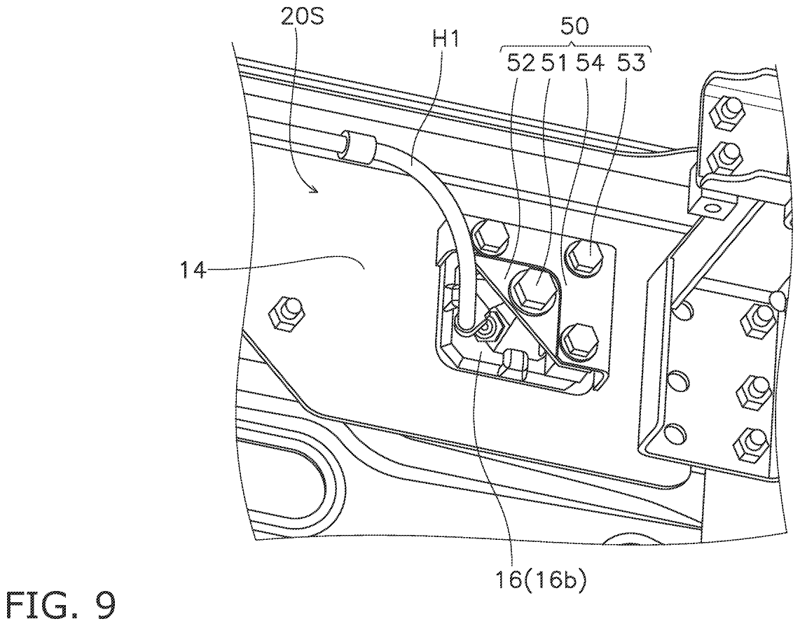

The fixing structure of the first GNSS antenna 16 will be explained with reference to the drawings. FIG. 6 is a rearward perspective view of the first GNSS antenna 16. FIG. 7 is a cross-sectional view of the fixing structure of the first GNSS antenna 16. FIG. 8 is an exploded perspective view of the fixing structure of the first GNSS antenna 16. FIG. 9 is a downward perspective view of the fixing structure of the first GNSS antenna 16 from the inside of the equipment room 20S.

As illustrated in FIGS. 6 and 7, the first GNSS antenna 16 has an upper part 16a and a lower part 16b. The upper part 16a is the portion of the first GNSS antenna 16 disposed above the left vehicle body upper surface frame 14. The lower part 16b is the portion of the first GNSS antenna 16 inserted into an opening part 14a of the left vehicle body upper surface frame 14. The upper part 16a has a pyramidal shape. Consequently, it is difficult to grasp the upper part 16a of the first GNSS antenna 16 with hands or a tool whereby the removal of the first GNSS antenna 16 from outside the left vehicle body upper surface frame 14 can be prevented.

As illustrated in FIG. 7, the lower part 16b has an outer surface 16T that faces an inner surface 14T of the opening part 14A of the left vehicle body upper surface frame 14. When the first GNSS antenna 16 is rotated about a belowmentioned first coupling member 51, the outer surface 16T of the lower part 16b abuts the inner surface 14T of the opening part 14a. As a result, the first GNSS antenna 16 itself cannot be rotated whereby the removal of the first GNSS antenna 16 from outside the left vehicle body upper surface frame 14 can be prevented.

As illustrated in FIGS. 7 and 9, the first GNSS antenna 16 is fixed to the left vehicle body upper surface frame 14 from the inside of the equipment room 20S by means of a fixing part 50. In the present disclosure, the fixing of the GNSS antennas to the frame signifies that the GNSS antennas attached to the frame can be removed from inside the frame but cannot be removed from outside the frame.

In the present embodiment, the fixing part 50 has the first coupling member 51, a first seat 52, second coupling members 53, and a second seat 54.

The first coupling member 51 fixes the first GNSS antenna 16 to the left vehicle body upper surface frame 14. The first coupling member 51 is fastened to the first GNSS antenna 16 from inside the equipment room 20S. The first coupling member 51 is inserted into an insertion hole 52a of the first seat 52. The first coupling member 51 is fastened to the first GNSS antenna 16 whereby the first GNSS antenna 16 is coupled to the first seat 52. The first coupling member 51 is fastened to the first GNSS antenna 16 from below. The first coupling member 51 is fastened to a lower part of the first GNSS antenna 16. While one first coupling member 51 is fastened to the center of the first GNSS antenna 16 in the present embodiment, the number and disposition of the first coupling member 51 may be changed as appropriate. While a bolt is used as the first coupling member 51 in the present embodiment, the first coupling member 51 may be any object that fastens the first GNSS antenna 16 to the first seat 52. For example, the first coupling member 51 may be a clamp or may be a joining part formed by welding.

The first seat 52 is a plate-like member. The first seat 52 is disposed below the opening part 14a of the left vehicle body upper surface frame 14. The first GNSS antenna 16 is disposed on the first seat 52. The first seat 52 is disposed approximately parallel to the left vehicle body upper surface frame 14 inside the equipment room 20S. The first seat 52 has the insertion hole 52a, nuts 52b, and a notch 52c. The first coupling member 51 is inserted into the insertion hole 52a. The nuts 52b are fixed to the upper surface of the first seat 52. The second coupling members 53 are fastened to the nuts 52b. The notch 52c is provided so as to allow the first harness H1 to pass through to the first GNSS antenna 16. In the present embodiment, because the first harness H1 extends from the first GNSS antenna 16 toward the right and front, the notch 52c is formed at the right front corner of the first seat 52.

The second coupling members 53 couple the first seat 52 to the second seat 54. The second coupling members 53 are inserted into the second seat 54 and the first seat 52 and are fastened to the nuts 52b of the first seat 52. Consequently, the second seat 54 is coupled to the first seat 52. While three second coupling members 53 are disposed in an L-shape in the present embodiment, the number and disposition of the second coupling members 53 may be changed as appropriate. In addition, while bolts are used as the second coupling members 53 in the present embodiment, the second coupling members 53 may be any object that is able to couple the first seat 52 to the second seat 54. For example, the second coupling members 53 may be clamps or may be joining parts formed by welding.

The second seat 54 is fixed to the left vehicle body upper surface frame 14. While the outer edge of the second seat 54 is welded to the inner surface of the left vehicle body upper surface frame 14 in the present embodiment, the method for fixing the second seat 54 to the left vehicle body upper surface frame 14 is not limited in particular.

The first seat 52 is coupled to the second seat 54 by means of the second coupling members 53. The coupling of the first seat 52 to the second seat 54 may be performed after coupling the first GNSS antenna 16 to the first seat 52 or may be performed before coupling the first GNSS antenna 16 to the first seat 52.

### Method for Attaching and Detaching First GNSS Antenna 16

A method for attaching and detaching the first GNSS antenna 16 will be explained with reference to the drawings.

Firstly, first and second removal methods of the first GNSS antenna 16 will be explained. The first GNSS antenna 16 does not need to be removed normally, but does need to be removed in the case of a failure or the like.

The first removal method is carried out as follows. Firstly, as illustrated in FIG. 2, the lock of the left side surface cover 30 is released and the left side surface cover 30 is opened to the open position. Next, the first harness H1 illustrated in FIG. 9 is detached from the first GNSS antenna 16 inside the equipment room 20S. Next, the first coupling member 51 illustrated in FIG. 9 is loosened and pulled out from the first GNSS antenna 16 inside the equipment room 20S. Next, the first GNSS antenna 16 is lifted up from above the left vehicle body upper surface frame 14 and removed from the vehicle body. Next, the left side surface cover 30 is returned to the closed position and locked.

The second removal method is carried out as follows. Firstly, as illustrated in FIG. 2, the lock of the left side surface cover 30 is released and the left side surface cover 30 is opened to the open position. Next, the first harness H1 illustrated in FIG. 9 is detached from the first GNSS antenna 16 inside the equipment room 20S. Next, the second coupling members 53 illustrated in FIG. 9 are loosened and pulled out from the second seat 54 inside the equipment room 20S. Next, the first GNSS antenna 16 coupled to the first seat 52 is lifted upward from above the left vehicle body upper surface frame 14 and removed from the vehicle body. Next, the left side surface cover 30 is returned to the closed position and locked. Next, the first coupling member 51 is loosened and pulled out from the first GNSS antenna 16, whereby the first seat 52 is removed from the first GNSS antenna 16.

First and second attachment methods of the first GNSS antenna 16 will be explained next.

The first attachment method is carried out as follows. Firstly, as illustrated in FIG. 6, the first GNSS antenna 16 is inserted into the opening part 4a from above the left vehicle body upper surface frame 14. Next, as illustrated in FIG. 2, the lock of the left side surface cover 30 is released and the left side surface cover 30 is opened to the open position. Next, the first coupling member 51 is fastened to the first GNSS antenna 16 through the insertion hole 52a of the first seat 52 from the inside of the equipment room 20S, whereby the first seat 52 is coupled to the first GNSS antenna 16. Next, the first harness H1 is inserted into the first GNSS antenna 16 inside the equipment room 20S. Next, the left side surface cover 30 is returned to the closed position and locked.

The second attachment method is carried out as follows. Firstly, the first coupling member 51 is fastened to the first GNSS antenna 16 through the insertion hole 52a of the first seat 52, whereby the first seat 52 is coupled to the first GNSS antenna 16. Next, the first GNSS antenna 16 coupled to the first seat 52 is inserted into the opening part 14a from above the left vehicle body upper surface frame 14. Next, as illustrated in FIG. 2, the lock of the left side surface cover 30 is released and the left side surface cover 30 is opened to the open position. Next, the second coupling members 53 are fastened to the nuts 52b of the first seat 52 from inside the equipment room 20S, whereby the second seat 54 is coupled to the first seat 52. Next, the first harness H1 is inserted into the first GNSS antenna 16 inside the equipment room 20S. Next, the left side surface cover 30 is returned to the closed position and locked.

As explained above, because the first GNSS antenna 16 is fixed to the left vehicle body upper surface frame 14 from inside the equipment room 20S by means of the fixing part 50, the first GNSS antenna 16 cannot be attached and detached without handling the first coupling member 51 or the second coupling members 53 from inside the equipment room 20S.

Moreover, because the cooling device 26 is disposed straddling below the left upper surface cover 21 and the engine hood 22, the fixing part 50 of the first GNSS antenna 16 cannot be accessed even if the engine hood 22 is opened to the open position. Consequently, the first GNSS antenna 16 cannot be detached without releasing the lock of the left side surface cover 30.

### Second GNSS Antenna 17

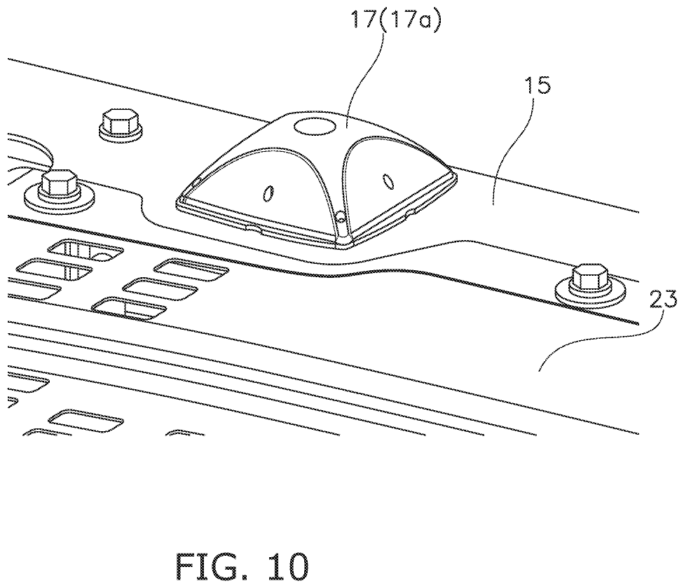

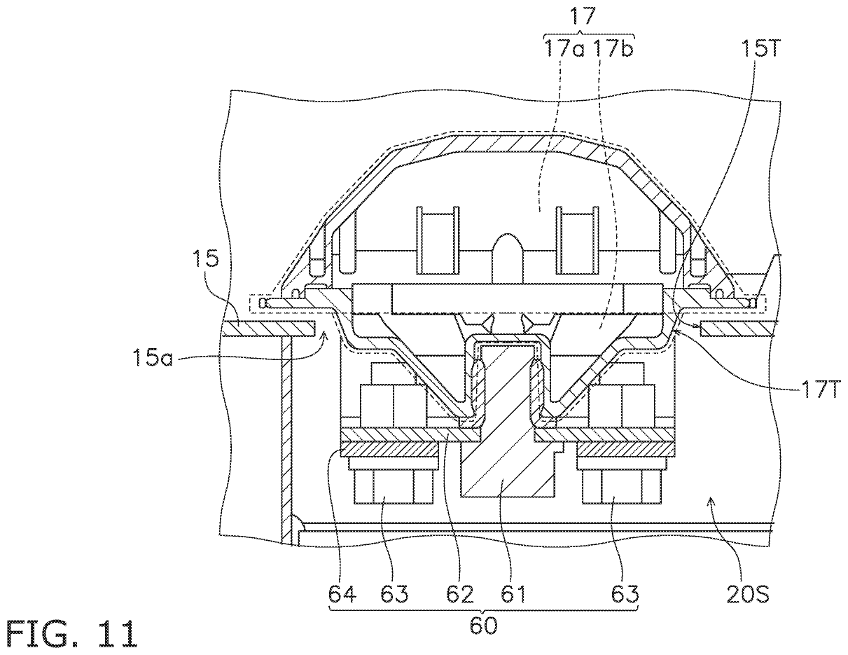

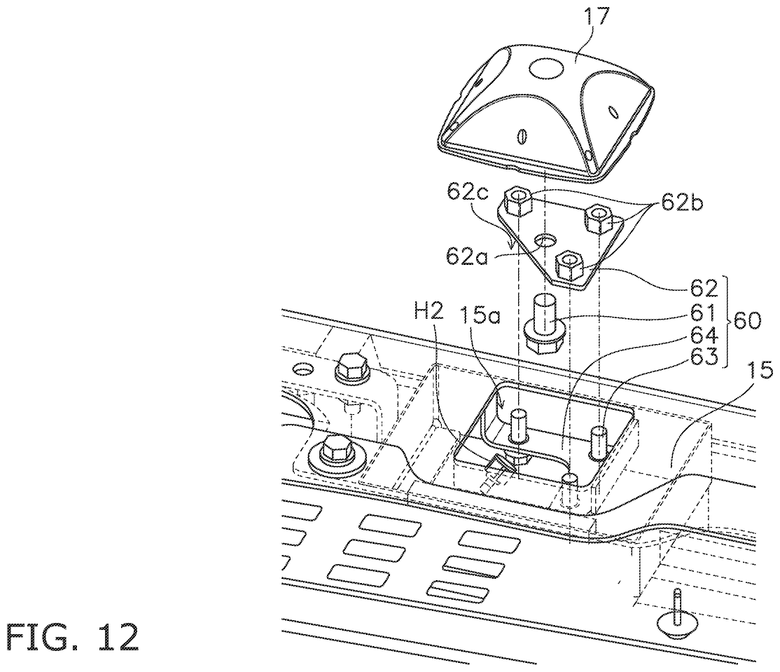

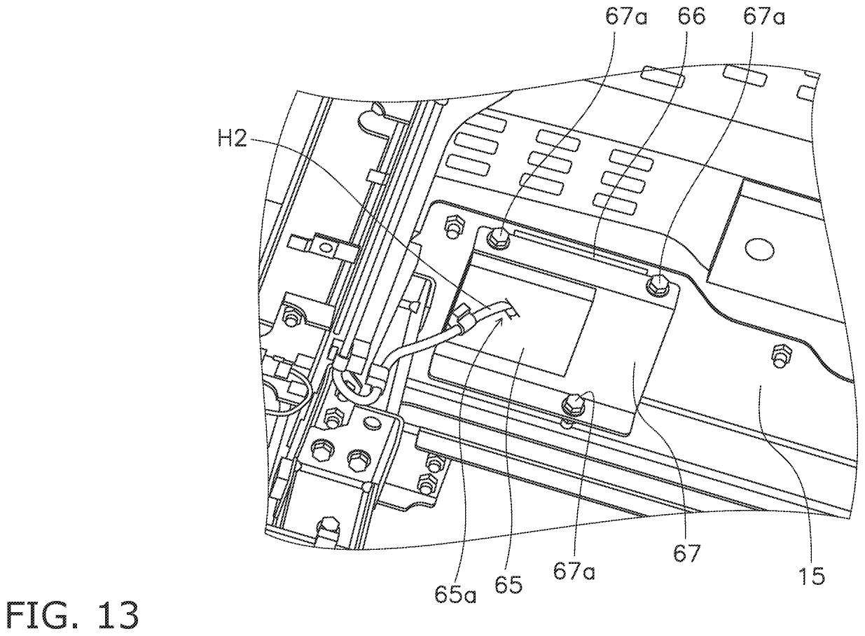

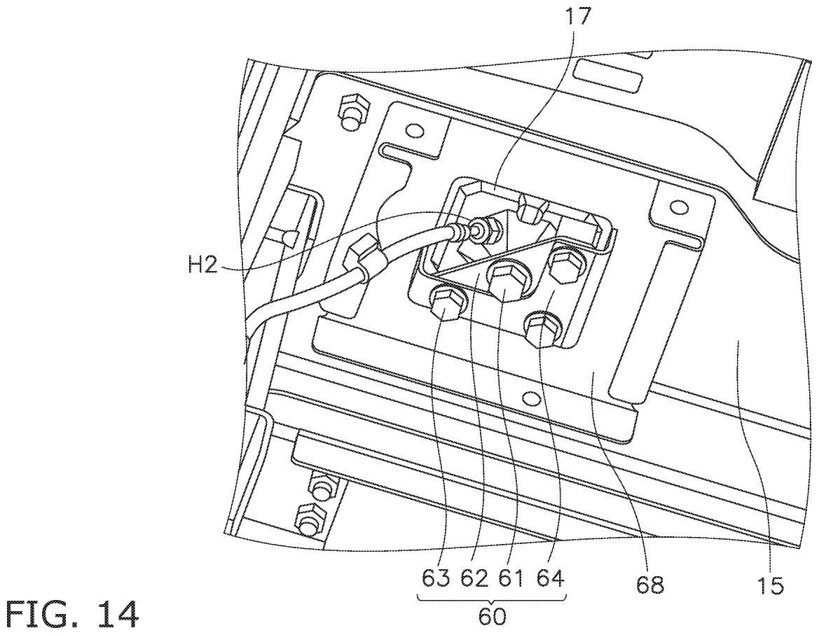

The fixing structure of the second GNSS antenna 17 will be explained with reference to the drawings. FIG. 10 is a rearward perspective view of the second GNSS antenna 17. FIG. 11 is a cross-sectional view of the fixing structure of the second GNSS antenna 17. FIG. 12 is an exploded perspective view of the fixing structure of the second GNSS antenna 17. FIG. 13 is a perspective view of an insulating member 65 seen from inside the equipment room 20S. FIG. 14 is a downward perspective view illustrating the first insulating member 65 while a second insulating member 66 and an attachment tool 67 are removed.

As illustrated in FIGS. 10 and 11, the second GNSS antenna 17 has an upper part 17a and a lower part 17b. The upper part 17a is a portion of the second GNSS antenna 17 is disposed above the right vehicle body upper surface frame 15. The lower part 17b is a portion of the second GNSS antenna 17 inserted into an opening part 15a of the right vehicle body upper surface frame 15.

The upper part 17a has a pyramidal shape. Consequently, it is difficult to grasp the upper part 16a of the second GNSS antenna 17 with hands or a tool whereby the removal of the second GNSS antenna 1 from outside the right vehicle body upper surface frame 15 can be prevented.

As illustrated in FIG. 1, the lower part 17b has an outer surface 17T that faces an inner surface 15T of the opening part 15a of the right vehicle body upper surface frame 15. When the second GNSS antenna 17 is rotated about a belowmentioned first coupling member 61, the outer surface 17T of the lower part 17b abuts the inner surface 15T of the opening part 15a. As a result, the second GNSS antenna 17 itself cannot be rotated whereby the removal of the second GNSS antenna 17 from outside the right vehicle body upper surface frame 15 can be prevented.

As illustrated in FIGS. 11 and 14, the second GNSS antenna 17 is fixed to the right vehicle body upper surface frame 15 from the inside of the equipment room 20S by means of a fixing part 60.

In the present embodiment, the fixing part 60 includes the first coupling member 61, a second seat 62, a second coupling member 63, a second seat 64, the first insulating member 65, the second insulating member 66, and the attachment tool 67.

The first coupling member 61 fixes the second GNSS antenna 17 to the right vehicle body upper surface frame 15. The first coupling member 61 is fastened to the second GNSS antenna 17 from inside the equipment room 20S. The first coupling member 61 is inserted into an insertion hole 62a of the first seat 62. The first coupling member 61 is fastened to the second GNSS antenna 17 whereby the second GNSS antenna 17 is coupled to the first seat 62. The first coupling member 61 is fastened to the second GNSS antenna 17 from below. The first coupling member 61 is fastened to a lower part of the second GNSS antenna 17. While one first coupling member 51 is fastened to the center of the second GNSS antenna 17 in the present embodiment, the number and disposition of the first coupling member 61 may be changed as appropriate. While a bolt is used as the first coupling member 61 in the present embodiment, the first coupling member 61 may be any object that is able to couple the second GNSS antenna 17 to the first seat 62. For example, the first coupling member 61 may be a clamp or may be a joining part formed by welding.

The first seat 62 is a plate-like member. The first seat 62 is disposed below the opening part 15a of the right vehicle body upper surface frame 15. The second GNSS antenna 17 is disposed on the first seat 62. The first seat 2 is disposed approximately parallel to the right vehicle body upper surface frame 15 inside the equipment room 20S. The first seat 62 has the insertion hole 62a, nuts 62b, and a notch 62c. The first coupling member 61 is inserted into the insertion hole 62a. The nuts 62b are fixed to the upper surface of the first seat 62. The second coupling members 63 are fastened to the nuts 62b. The notch 62c is provided so as to allow a second harness H2 to pass through to the second GNSS antenna 17. In the present embodiment, because the second harness H2 extends from the second GNSS antenna 17 toward the left and front, the notch 62c is formed at the left front corner of the first seat 62.

The second coupling members 63 couple the first seat 62 to the second seat 64. The second coupling members 63 are inserted through the second seat 64 and the first seat 62 and are coupled to the nuts 62b of the first seat 62. Consequently, the second seat 64 is coupled to the first seat 62. While three second coupling members 63 are disposed in an L-shape in the present embodiment, the number and disposition of the second coupling members 63 may be changed as appropriate. In addition, while bolts are used as the second coupling members 63 in the present embodiment, the second coupling members 63 may be any object that is able to couple the first seat 62 to the second seat 64. For example, the second coupling members 63 may be clamps or may be joining parts formed by welding.

The second seat 64 is fixed to the right vehicle body upper surface frame 15. While the outer edge of the second seat 64 is welded to the inner surface of the right vehicle body upper surface frame 15 in the present embodiment, the method for fixing the second seat 64 to the right vehicle body upper surface frame 15 is not limited in particular.

The first seat 62 is coupled to the second seat 64 by means of the second coupling members 63. The coupling of the first seat 62 to the second seat 64 may be performed after coupling the second GNSS antenna 1 to the first seat 62 or may be performed before coupling the second GNSS antenna 17 to the first seat 62.

The first insulating member 65 and the second insulating member 66 are disposed between the second GNSS antenna 17 and the heat source 28 inside the equipment room 20S. The first insulating member 65 is disposed below the second GNSS antenna 17. The second insulating member 66 is disposed beside the second GNSS antenna 17. An insertion hole 65a for inserting the second harness H2 is formed in the first insulating member 65. The first insulating member 65 and the second insulating member 66 are fixed to the attachment tool 67. A well-known insulating material may be used as the first insulating member 65 and the second insulating member 66.

The attachment tool 67 is attached to the supporting member 68 by means of three bolts 67a. The supporting member 68 is welded to the right vehicle body upper surface frame 15. However, the method for fixing the supporting member 68 to the right vehicle body upper surface frame 15 is not limited in particular, and the supporting member 68 may be clamped or bolted.

### Method for Attaching and Detaching Second GNSS Antenna 17

A method for attaching and detaching the second GNSS antenna 17 will be explained with reference to the drawings.

Firstly, first and second removal methods of the second GNSS antenna 17 will be explained. The second GNSS antenna 17 does not need to be removed normally, but does need to be removed in the case of a failure or the like.

The first removal method is carried out as follows. Firstly, as illustrated in FIG. 4, the lock of the right side surface cover 40 is released and the right side surface cover 40 is opened to the open position. Next, the attachment tool 67 illustrated in FIG. 13 is removed inside the equipment room 20S. Next, the second harness H2 illustrated in FIG. 14 is detached from the second GNSS antenna 17 inside the equipment room 20S. Next, the first coupling member 61 illustrated in FIG. 14 is loosened and pulled out from the second GNSS antenna 17 inside the equipment room 20S. Next, the second GNSS antenna 17 is lifted up from above the right vehicle body upper surface frame 15 and removed from the vehicle body. Next, the right side surface cover 40 is returned to the closed position and locked.

The second removal method is carried out as follows. Firstly, as illustrated in FIG. 4, the lock of the right side surface cover 40 is released and the right side surface cover 40 is opened to the open position. Next, the three bolts 67a illustrated in FIG. 13 are loosened and pulled out inside the equipment room 20S, and thereafter the attachment tool 67 is removed from the supporting member 68. Next, the second harness H2 illustrated in FIG. 14 is detached from the second GNSS antenna 17 inside the equipment room 20S. Next, the second coupling members 63 illustrated in FIG. 14 are loosened and pulled out from the second seat 64 inside the equipment room 20S. Next, the second GNSS antenna 17 coupled to the first seat 62 is lifted upward from above the right vehicle body upper surface frame 15 and removed from the vehicle body. Next, the right side surface cover 40 is returned to the closed position and locked. Next the first seat 62 is removed from the second GNSS antenna 17 by loosening the first coupling member 61 and pulling the first coupling member 61 away from the second GNSS antenna 17.

First and second attachment methods of the second GNSS antenna 17 will be explained next.

The first attachment method is carried out as follows. Firstly, as illustrated in FIG. 10, the second GNSS antenna 17 is inserted into the opening part 15a from above the right vehicle body upper surface frame 15. Next, as illustrated in FIG. 4, the lock of the right side surface cover 40 is released and the right side surface cover 40 is opened to the open position. Next, the first coupling member 61 is fastened to the second GNSS antenna 17 via the insertion hole 62a of the first seat 62 from inside the equipment room 20S, whereby the first seat 62 is coupled to the second GNSS antenna 17. Next, the second harness H2 is inserted into the second GNSS antenna 17 from inside the equipment room 20S. Next, as illustrated in FIG. 13, the attachment tool 67 to which the first insulating member 65 and the second insulating member 66 are applied, is fastened to the supporting member 68. Next, the right side surface cover 40 is returned to the closed position and locked.

The second attachment method is carried out as follows. Firstly, the first coupling member 61 is fastened to the second GNSS antenna 17 via the insertion hole 62a of the first seat 62, whereby the first seat 62 is coupled to the second GNSS antenna 17. Next, the second GNSS antenna 17 coupled to the first seat 52 is inserted into the opening part 15a from above the right vehicle body upper surface frame 15. Next, as illustrated in FIG. 4, the lock of the right side surface cover 40 is released and the right side surface cover 40 is opened to the open position. Next, the second coupling members 63 are fastened to the nuts 62b of the first seat 62 from inside the equipment room 20S, whereby the second seat 64 is coupled to the first seat 62. Next, the second harness H2 is inserted into the second GNSS antenna 17 inside the equipment room 20S. Next, as illustrated in FIG. 13, the attachment tool 67 to which the first insulating member 65 and the second insulating member 66 are applied, is fastened to the supporting member 68. Next, the right side surface cover 40 is returned to the closed position and locked.

As indicated above, because the second GNSS antenna 17 is fixed to the right vehicle body upper surface frame 15 from inside the equipment room 20S by means of the fixing part 60, the second GNSS antenna 17 cannot be detached without handling the first coupling member 61 or the second coupling members 63 from inside the equipment room 20S.

Moreover, because the heat source 28 or the auxiliary machine 29 is disposed below the right upper surface cover 22 and the engine hood 22, the fixing part 60 of the second GNSS antenna 17 cannot be accessed even if the engine hood 22 is opened to the open position. Consequently, the second GNSS antenna 17 cannot be detached without releasing the lock of the right side surface cover 40.

### Characteristics

The hydraulic excavator 1 comprises the left vehicle body upper surface frame 14, the equipment room 20S, and the fixing part 50. The equipment room 20S is positioned below the left vehicle body upper surface frame 14. The fixing part 50 fixes the first GNSS antenna 16 to the left vehicle body upper surface frame 14 from inside the equipment room 20S so that at least a portion of the first GNSS antenna 16 is disposed above the left vehicle body upper surface frame 14.

Therefore, because removal of the first GNSS antenna 16 from outside can be prevented, theft of the first GNSS antenna 16 is difficult. Consequently, there is no need to remove the first GNSS antenna 16 and store the first GNSS antenna 16 after work is finished. Additionally, degradation of the first harness H1 due to repeatedly attaching and detaching the first GNSS antenna 16 can be suppressed. Additionally, in comparison to disposing the first GNSS antenna 16 at the tip of a mast, not only is it easy to clear height restrictions during transport, but also the risk of contact with surrounding structures can be reduced and instability of the ability to receive caused by vibration can be suppressed.

The above effects are also achieved by providing the fixing part 60 that fixes the second GNSS antenna 17 to the right vehicle body upper surface frame 15 from inside the equipment room 20S so that at least a portion of the second GNSS antenna 17 is disposed above the right vehicle body upper surface frame 15.

### Modified Examples of the Embodiment

The present invention is not limited to the above embodiments and various changes and modifications may be made without departing from the spirit of the invention.

### Modified Example 1

While a hydraulic excavator has been used as an example of the work machine in the above embodiment, the work machine is not limited to a hydraulic excavator. For example, a power shovel or a wheel loader or the like may be used as the work machine.

### Modified Example 2

While the first GNSS antenna 16 and the second GNSS antenna 17 have been explained as examples of antennas in the above embodiment, the present invention is not limited to antennas. For example, a radio antenna may be exemplified as the antenna.

### Modified Example 3

In the present embodiment, while the fixing part 50 has the first coupling member 51, the first seat 52, the second coupling members 53, and the second seat 54, the present invention is not limited thereto.

For example, the fixing part 50 may be one coupling member and, for example, may only be the first coupling member 51. In this case, the first GNSS antenna 16 is placed on the left vehicle body upper surface frame 14 and can be fixed directly to the left vehicle body upper surface frame 14 by means of the first coupling member 51 that is inserted through the left vehicle body upper surface frame 14. In this case, all of the first GNSS antenna 16 is disposed above the left vehicle body upper surface frame 14. However, the fixing part 50 in this case is preferably provided with a structure does not allow the first GNSS antenna 16 itself to be rotated and removed such as a structure that hinders rotation of the first GNSS antenna 16, or a structure in which the first coupling member 51 rotates in conjunction with the rotation of the first GNSS antenna 16.

Alternatively, the fixing part 50 may be configured by one coupling member and one seat. In this case, the first GNSS antenna 16 is placed on the one seat and can be fixed to the seat by means of the one coupling member that is passed through the seat. In this case, a portion of the first GNSS antenna 16 is disposed above the left vehicle body upper surface frame 14 in the same way as the above embodiment.

### Modified Example 4

While the hydraulic excavator 1 is provided with the first GNSS antenna 16 from the beginning in the above embodiment, the first GNSS antenna 16 may also be retrofitted.

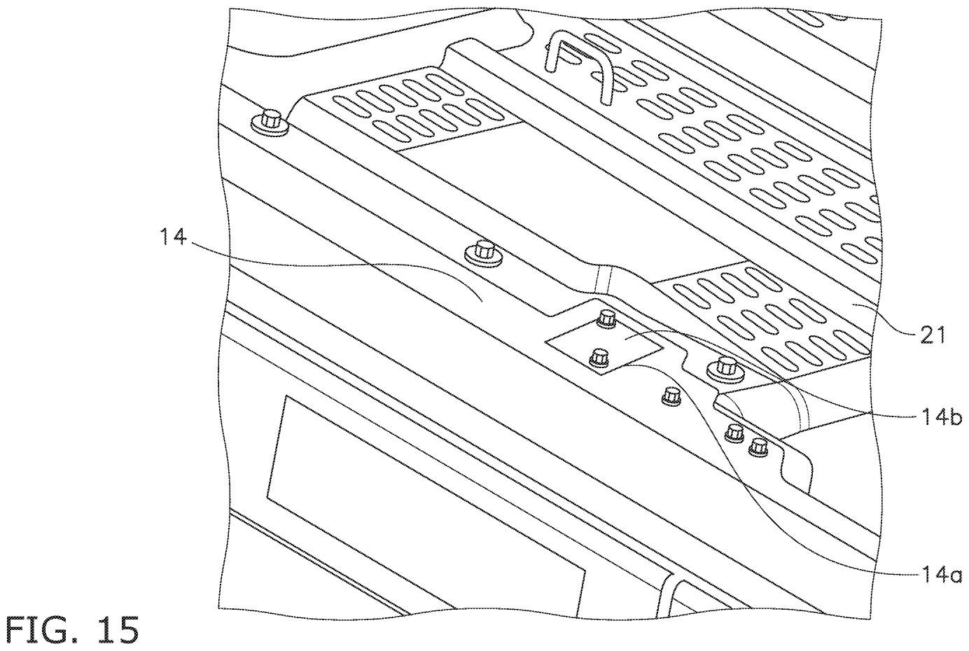

For example, as illustrated in FIG. 15, when the hydraulic excavator 1 is not provided with the first GNSS antenna 16, the opening part 14a of the left vehicle body upper surface frame 14 is covered by a lid 14b. When attaching a new first GNSS antenna 16, the lid 14b is removed and the first GNSS antenna 16 can be attached as explained in the above embodiment.

### Appendix 1

A work machine comprising a vehicle body upper surface frame, a housing space positioned below the vehicle body upper surface frame, and a fixing part that is configured to fix an antenna to the vehicle body upper surface frame from inside the housing space so that at least a portion of the antenna is disposed above the vehicle body upper surface frame.

### Appendix 2

The work machine described in appendix 1, wherein the fixing part includes a first coupling member that fixes the antenna to the vehicle body upper surface frame.

### Appendix 3

The work machine described in appendix 2, wherein the fixing part includes a seat on which the antenna is disposed, and the first coupling member fixes the antenna to the vehicle body upper surface frame via the seat.

### Appendix 4

The work machine described in appendix 3, wherein: the seat includes a first seat on which the antenna is disposed and a second seat that is fixed to the vehicle body upper surface frame; the first coupling member couples the antenna to the first seat; and the fixing part further includes a second coupling member that couples the first seat to the second seat.

### Appendix 5

The work machine described in any of appendixes 2-4, wherein the antenna has a lower part that is inserted into an opening part of the vehicle body upper surface frame, and when the antenna is rotated about the first coupling member, an outer surface of the lower part abuts an inner surface of the opening part.

### Appendix 6

The work machine described in any of appendixes 1-5, wherein an upper part of the antenna disposed above the vehicle body upper surface frame has a pyramidal shape.

### Appendix 7

The work machine described in any of appendixes 1-6, wherein the fixing further includes a heat insulation member that is disposed between the antenna and a heat source in the housing space.

### Appendix 8

The work machine described in any of appendixes 1-6, wherein the exterior cover includes a side surface cover that covers a side of the housing space, and the side surface cover an be opened and closed and can be locked in the closed position.

1. A work machine comprising:
a vehicle body upper surface frame;
a housing space positioned below the vehicle body upper surface frame; and
a fixing part configured to fix an antenna to the vehicle body upper surface frame from inside the housing space so that at least a portion of the antenna is disposed above the vehicle body upper surface frame.

2. The work machine according to claim 1, wherein
the fixing part includes a coupling member that fixes the antenna to the vehicle body upper surface frame.

3. The work machine according to claim 2, wherein
the fixing part includes a seat on which the antenna is disposed, and
the coupling member fixes the antenna to the vehicle body upper surface frame via the seat.

4. The work machine according to claim 3, wherein
the seat includes
a first seat on which the antenna is disposed, and
a second seat fixed to the vehicle body upper surface frame, and
the coupling member includes
a first coupling member that couples the antenna to the first seat, and
a second coupling member that couples the first seat to the second seat.

5. The work machine according to claim 2, wherein
the antenna has a lower part that is inserted into an opening part of the vehicle body upper surface frame, and
when the antenna is rotated about the first coupling member, an outer surface of the lower part abuts an inner surface of the opening part.

6. The work machine according to claim 1, wherein
an upper part of the antenna disposed above the vehicle body upper surface frame has a pyramidal shape.

7. The work machine according to claim 1, wherein
the fixing part further includes a heat insulation member that is disposed between the antenna and a heat source in the housing space.

8. The work machine according to claim 1, wherein
an exterior cover includes a side surface cover that covers a side of the housing space, and
the side surface cover can be opened and closed and can be locked in the closed position.
